(19) United States
(12) Patent Application Publication
(10) Pub. No.: US 2011/0215705 A1
(43) Pub. Date: Sep. 8, 2011

(54) MICRO-CHIP PLASMONIC SOURCE

(76) Inventors: James Peter Long, Accokeek, MD (US); Chul-soo Kim, Springfield, VA (US); James R. Lindle, Bowie, MD (US); Jerry R. Meyer, Catonsville, MD (US); Igor Vurgaftman, Odenton, MD (US)

(21) Appl. No.: 12/717,989

(22) Filed: Mar. 5, 2010

(51) Int. Cl. H01J 61/28

(52) U.S. Cl. 313/231.31

(57) ABSTRACT

A surface plasmon polariton device that may be integrated onto a single microchip is disclosed. The device employs a laser that emits polarized light across a gap into a plasmonic waveguide. Surface plasmon polaritons are thereby created in an efficient matter. The device provides a source of surface plasmon polaritons at near infrared wavelengths in an integrated package.

### BACKGROUND OF THE INVENTION

1. Field of the Invention

The field of the invention is directed towards plasmonic devices. In particular the present invention is directed towards integrated electro-optic devices.

2. Description of the Related Technology

Plasmonics is a rapidly expanding field that employs various forms of surface plasmons to manipulate optical energy at increasingly smaller spatial scales. The field promises to miniaturize photonics beyond present capabilities into the nanoscale region. The field may also provide advanced chemical sensing capabilities through surface-enhanced Raman scattering (SERS), surface-enhanced infrared spectroscopy, and surface-enhanced fluorescence.

Currently there is no compact, intense, electrically driven source of surface plasmon polaritons (SPPs) in the near infrared or visible spectrum. A SPP is a running-wave of optical energy that is confined to the interface between a conductor and an overlying dielectric. The conductor is often a simple thin metal film, but can be fashioned into a waveguide as a stripe, cylinder, or other cross section. SPPs are of great importance to the field of plasmonics in transporting plasmonic energy. SPPs are the basis of surface plasmon resonance (SPR) sensing, and are actively used in nano- and micro-scale waveguide research.

SPPs may be generated in a variety of ways, most of which entail an external light source. By necessity most optical methods must overcome the physically disallowed direct coupling of light to SPPs that arises because the SPP wavelength is less than that of light at the same frequency. An alternative method places optically or electrically excited fluorophores or electron-hole pairs in close proximity to a metal and exploits the direct quenching of optical dipoles into SPPs. Another method involves coupling an electron beam to SPPs on metal surfaces to provide direct means for exciting SPPs. However this method is not amenable to the production of efficient miniature sources.

Methods that employ phase matching to overcome the disallowed direct coupling of light to SPPs include gratings and the classic Kretschmann configuration.

In the Kretschmann approach, light is aimed into a prism and reflected from a partially transparent metal film that is in contact with one side of the prism. For a given wavelength, efficient coupling to SPPs is achieved through controlling the angle of incidence on the film and the film thickness. The Kretschmann method requires bulky equipment and tight control of the metal film thickness, and radiates SPP energy back into the prism as light, which halves propagation lengths even at the most efficient coupling.

The grating method replaces a prism with a grating impressed in the metal surface to achieve phase matching. As with the Kretschmann arrangement, the grating method requires control of the angle of incidence to permit efficient coupling at a particular optical wavelength. The method is compact and is amenable to thick films that do not re-radiate optical energy, but as currently practiced requires a bulky external light source and optics to couple the light to the grating.

Additionally, optical fibers have been used to launch SPPs on thick or thin metal films by illuminating the edge of the film, where the radiation is converted to SPPs. This method has been demonstrated by orienting the optical fiber parallel to the film and bringing the end of the fiber into close proximity with the end of the film. Since the method again requires an external light source and also manipulation of the fiber (or bulky lens system) with great precision (at submicron levels), it is impractical for many applications.

Attempts at integrating SPP sources are just beginning. A recent publication describes the use of an organic light-emitting diode (OLED) fabricated directly on a metal film. In this approach, electron-hole pairs are electrically excited within the OLED and quenched into SPPs propagating on the metal film. Any LED-based approach will be limited in available power and will not provide a coherent, monochromatic source. An OLED-based approach is also less robust than an approach based on inorganic semiconductors.

An integrated plasmonic device that relies on SPPs, but which does not serve as a SPP source, can be built at much longer wavelengths, for example around a cascade laser at 7.5 μm. In this situation a metal film is deposited as an electrode in close proximity to and parallel to a planar semiconducting gain medium. The evanescent field of the SPP mode supported by the metal film overlaps the gain region, so that SPPs replace the function of the waveguide photon-mode circulating in a laser cavity. The output of the device is purely photonic in nature, since SPPs are converted into free-space photons at the laser output mirror. This approach cannot be extended to the NIR or visible regions without fundamental changes in architecture because of increased losses in the metal film at the shorter wavelengths. No path to overcoming these losses has yet been demonstrated. Generation of SPPs in a mode with an area below the diffraction limit is also quite challenging.

Other plasmonic functionality has been integrated with laser diodes by locating metal features directly on the output facet of the laser. The goal in this configuration is to achieve nanoscale light confinement by exciting plasmonic antennas or to improve collimation of the emission from a quantum cascade laser. This approach has not been used as a source of SPPs.

Two additional classes of superficially related devices include (i) plasmon-enhanced LEDs, in which either SPPs or localized surface plasmons are excited in an electrode via quenching of the diode's electrically pumped electron-hole pairs, and the plasmons are subsequently converted to light through patterning of the electrode, and (ii) plasmon-enhanced photodiodes or photovoltaics in which the incident light is converted into electrical current by reversing the process. Neither of these classes of devices serves, or is designed to serve, as a source of SPPs.

Therefore there is need in the field to provide an integrated source of SPPs that can be extended into the NIR or visible spectrum, that can produce high power, and that can potentially be applied to produce SPPs with subdiffraction modal areas.

### SUMMARY OF THE INVENTION

An object of the present invention may be an integrated SPP device.

Another object of the present invention may be a method for producing SPPs.

Still yet another object of the present invention may be an electrically activated SPP device.

An aspect of the present invention may be a surface plasmon polariton device comprising: a substrate; a laser for emitting electromagnetic radiation located on the substrate; a plasmonic waveguide adapted for receiving the electromagnetic radiation, wherein the plasmonic waveguide is located on the substrate; a gap across which the electromagnetic radiation traverses from the laser to the plasmonic waveguide; and wherein the plasmonic waveguide converts the electromagnetic radiation into surface plasmon polaritons.

Another aspect of the present invention may be a microchip having a surface plasmon polariton device comprising: a surface plasmon polariton device integrated on a chip; wherein the surface plasmon polariton device comprises: a laser for emitting electromagnetic radiation located on a substrate; a waveguide adapted for receiving the electromagnetic radiation located on the substrate; a gap across which the electromagnetic radiation traverses; and wherein the waveguide converts the electromagnetic radiation into surface plasmon polaritons.

Still yet another aspect of the present invention may be a method of producing surface plasmon polaritons comprising: producing electromagnetic radiation at a laser located on a substrate; transmitting the electromagnetic radiation across a gap; striking a waveguide with the electromagnetic radiation, wherein the waveguide is located on the substrate; and converting the electromagnetic radiation into surface plasmon polaritons.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram of an integrated SPP device made in accordance with an embodiment of the present invention.

FIG. 2 is a perspective view of an integrated SPP device that utilizes a narrow ridge design.

FIG. 3 is a diagram of an embodiment of an integrated SPP device that uses a plurality of lasers and waveguides on the same chip.

FIG. 4 is a diagram of an embodiment of an integrated SPP device that uses one laser and more than one waveguide.

FIG. 5 is a diagram of an embodiment of an integrated SPP device that uses a laser and a waveguide that branches into sub-waveguides.

FIG. 6 is a diagrammatic view of an alternative embodiment of an integrated SPP device that utilizes a laser and a hybrid plasmonic waveguide comprising a dielectric ridge in contact with a metal film. The figure illustrates use of a dielectric ridge to effect branching into sub-waveguides as in FIG. 5.

FIG. 7 is a diagrammatic view of an alternative embodiment of an integrated SPP device that utilizes a grating to improve coupling into a subwavelength groove plasmonic waveguide.

FIG. 8 is a perspective view of another embodiment of an integrated SPP device wherein the waveguide is tapered to increase SPP intensity at the end of the guide.

### DETAILED DESCRIPTION OF THE PREFERRED EMBODIMENT(S)

The present invention provides a convenient, miniaturized, electrically driven source of surface plasmon polaritons on a substrate, which may then be used as a micro-chip. The architecture of the present invention is suited for integration with electro-optic devices and for obtaining an efficient source of SPPs in a micro-chip package.

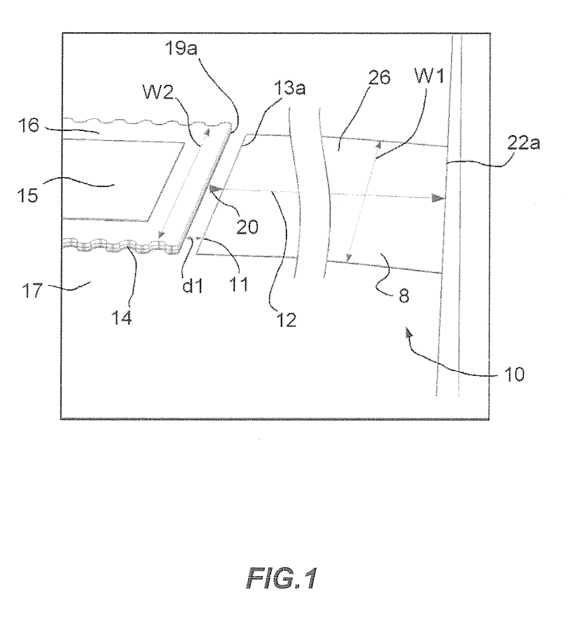

FIG. 1 shows a schematic of the SPP device 10 that is made in accordance with an embodiment of the present invention. The SPP device 10 is typically embodied as a micro-chip or used in the formation of a micro-chip. The SPP device 10 uses a diode laser 16 to generate intense electro-magnetic radiation. The laser 16 may be selected from a group comprising a ridge laser, a vertical-cavity surface-emitting laser (VCSEL) and a patterned laser output facet. Connected to the laser 16 are electrical contact leads 15 used to drive the laser 16. The laser 16 employs InGaAs quantum wells 14 and produces an output beam 20 whose electric field is polarized vertically (transverse magnetic, or TM) that is emitted from the output facet 19a of the laser 16. The output beam 20 crosses the gap 11 to then strike the waveguide leading edge 13a which in turn excites surface plasmon polaritons 12 on the metal waveguide 22a.

The output beam 20 radiation may be at ˜1.4-μm wavelength when emitted from the output facet 19a from the diode laser 16 and is converted to SPPs at the leading edge 13a of the plasmonic waveguide 22a. The wavelength range used in the present invention may be any for which lasing can be produced, with the preferred range being between 0.38-2.0 μm. The laser 16 employs InGaAs quantum wells 14 under tensile strain within a ridge-architecture on an InP substrate 17 to produce a TM polarized output. The InP substrate 17 is the base structure for the SPP device 10 and is used in forming the chip. In this embodiment, the laser beam 20 is TM-polarized in order to match the polarization of the SPPs 12 for non-negligible coupling efficiency. The scattering of the free-space light into the SPP mode can occur in the vicinity of any discontinuity in the plasmonic waveguide 22a, in this case the discontinuity being the waveguide termination, and attains the maximum efficiency when the vertical extent of the light beam matches that of the SPP mode as closely as possible. A wide variety of other substrates, layered semiconductor gain media, and waveguide configurations may be used.

In the embodiment shown in FIG. 1 the plasmonic waveguide 22a is a 100-nm optically thick Au stripe, but other metals and thicknesses may be used. For stripes wider than several wavelengths, thicker films are suitable but offer little improvement in surface plasmon polariton propagation length. For stripe widths narrower than several wavelengths, there is an optimum metal thickness for most wavelengths that is not too far from 100 nm.

Some of the light from the laser 16 may also couple to SPPs via roughness as the light propagates above the metal waveguide 22a, but end coupling at the leading edge 13a with the output beam 20 is the main intended conversion mechanism for the embodiment used herein.

In the present embodiment of the SPP device 10, laser 16 is a 2 mm long by 150-μm wide laser cavity (W2). The waveguide 22a is a 100-nm thick×150-μm-wide (W1) Au stripe plasmonic guide. The gap 11 has a distance d1 that exists between the output facet 19a of the laser 16 and the leading edge 13a of the waveguide 22a and is about 6.6 μm. A smaller gap width is preferable to achieve high coupling efficiency, and the invention does not require the presence of a gap. In practice, the preferred gap width may be determined primarily by the convenience of processing by optical or electron beam lithography. The gap 11 is necessary in the current embodiment for ease of fabrication. In principle, the gap 11 may have a substantially zero width. Epitaxial-down mounting may be used in order to obtain a substantially zero-width gap. In the most general view, an arrangement is configured to ensure conversion of laser radiation (photons) into SPPs propagating on the integrated plasmonic waveguide. In the present embodiment the arrangement is end-coupling. Another arrangement, referred to below, may be a grating if a plasmonic waveguide were fabricated directly on a laser output facet, as in a VCSEL.

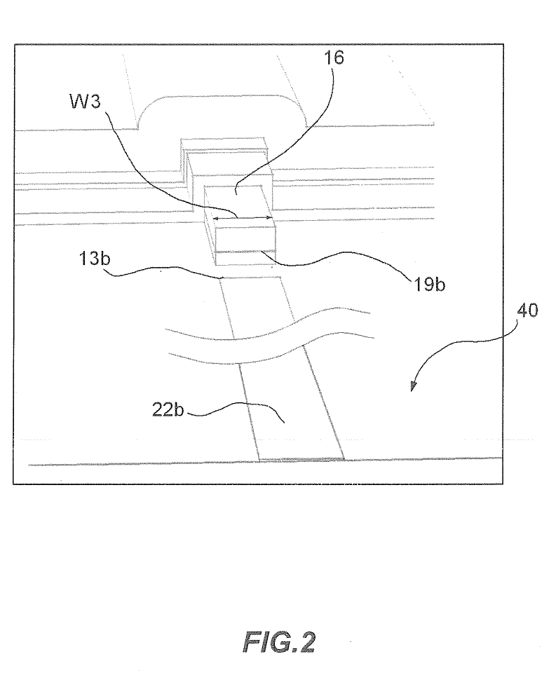

The relatively wide ridge laser 16 is designed to emit a TM polarized mode for efficient coupling to the similarly polarized plasmonic modes of the planar-stripe plasmonic waveguide 22a. The width W2 of the output facet 19a of the laser 16 is about 150 microns wide. The wide-ridge design of the laser 16 limits the effectiveness of thermal dissipation and necessitates pulsed operation at room temperature to reduce the local temperature rise. Narrowing the width of the output facet 19a to the 5 micron scale. i.e. output facet 19b having a W3 of 5 microns, as shown in FIG. 2, remains readily accessible to optical lithography and may improve thermal dissipation. Furthermore, the output facet 19a may be 2-3 times the emission wavelength to ensure a single lateral mode, whereas a width many times wider than a wavelength will support multi-transverse modes. Likewise the leading edge 13b of the waveguide may have a width not much greater than about W3 to maintain SPP intensity. Epitaxial-side-down mounting of the chip may also improve thermal dissipation for continuous or high-duty-cycle operation of either wide or narrow laser ridges. Epitaxial-side-down mounting directly onto a stripe plasmonic waveguide would represent a coupling gap of zero width.

A narrow ridge design for a SPP device 40 is shown in FIG. 2. The SPP device 40 provides the advantages of continuous wave operation at room temperature, single-lateral-mode operation, and improved coupling efficiency to narrower waveguides 22b.

Other diode-laser configurations may be employed to excite the plasmonic waveguides. Single-spectral-mode operation may be achieved by incorporating a distributed feedback (DFB) or distributed-Bragg-reflection (DBR) grating into the laser cavity. Single-spectral-mode operation may also be achieved by using an external-cavity grating on the cleaved back facet of the laser 16. Vertical-cavity surface emitting lasers (VCSELs) may also excite a plasmonic waveguide running above the output face if a coupling grating were fabricated into the waveguide.

Many diode-laser materials other than the InGaAs used in the present embodiment may be employed to excite different wavelengths on integrated plasmonic guides. GaAs and AlGaAs systems may be used for near infrared and visible applications. Type-I or type-II antimonide lasers, including an interband cascade laser, may be used at mid-IR wavelengths in the 2-5 μm range. Infrared wavelengths longer than 4 μm, and extending beyond 100 μm, may be accessed with quantum cascade lasers. It should be understood that the materials discussed above are only examples, and other semiconductor laser systems are also possible.

Still referring to the embodiment shown in FIG. 1, at room temperature the SPP device 10 was operated in a pulsed mode that produced 36 mW of SPP power at a laser drive current of 2 A when the characterized photon-to-plasmon conversion efficiency of about 36% is assumed. A similar continuous or average power may be achievable when heat sinking of the SPP device 10 is improved. Heat sinking improvement may be accomplished by well known art methods such as epitaxial-side-down mounting or narrowing the ridge laser 16 and overcoating the ridge laser with electroplated Au.

For devices operating at wavelengths in the blue and green portion of the visible spectrum, silver may be the preferred metal if the longest plasmon propagation lengths are desired. For wavelengths in the red and longer, gold becomes competitive with respect to propagation length and is preferred for many applications because its chemical inertness leads to stable plasmonic performance. As the wavelength increases into the near infrared, and especially into the short-, mid- and long-wavelength infrared, the optical constants of many other metals allow for waveguides with usefully long plasmon propagation lengths. Possible metals include, but are not limited to (listed in order of decreasing plasmon propagation length at a wavelength of 3 microns): copper, aluminum, chromium, platinum, palladium and nickel.

The SPP device 10 is the first SPP device to provide a source of SPPs at NIR wavelengths in an integrated package. With the exception of OLED-based sources, discussed above, the SPP device 10 is the only package that requires only an electrical source for operation, via the electrical contact leads 15. However, the SPP device 10 of the present invention has advantages over the OLED based design in that it can operate at telecommunications wavelengths in the 1.3-1.6 μm range, in addition to visible wavelengths. Furthermore, the SPP device 10 possesses the robustness intrinsic to solid-state inorganic semiconducting devices. The SPP device 10 additionally provides SPPs with much greater spatial and spectral coherence. The SPP device 10 is also much more efficient for practical use because the SPP beam energy is inherently collimated and orders of magnitude more powerful. Additionally, compared to standard methods for creating SPPs, the SPP device 10 is more compact and lighter because it does not require an external light source and associated coupling optics. It is thus suitable for lightweight platforms or complex applications such as distributed network sensing.

The embodiment shown in FIG. 1 also uses an InP substrate on which is grown an InGaAsP waveguide core enclosing InGaAs quantum wells grown with infrequently employed tensile strain so as to match the laser 16 to the SPP TM mode-polarization. The SPP device 10 further involves configuring the plane of the top surface 8 of the metal film waveguide 22a to lie below the laser gain-medium by an amount dependent on the width of the gap 11 for maximum mode overlap. The desired distance below the gain medium is approximately equal to the gap width times the tangent of the half-width of the angular divergence of the beam emerging from the laser facet. The SPP device 10 also involves tailoring the distance of the gap 11 and the width W1 of the waveguide 22a to optimize mode overlap depending on the vertical laser waveguide design as well as the width W of the leading edge 13a for very narrow ridges. In an embodiment, as in FIG. 1 utilizing a gap 11, a smaller gap width d1 produces improved mode overlap and increased laser-to-SPP coupling efficiency. For maximal power transfer, the width W1 of the waveguide 22a should be the same or slightly wider than that of the laser edge width W2. The width W2 of the ridge laser 16 in turn can be varied depending on the application. To operate with a single-lateral-mode for efficient focusing and uniform performance requires the narrowest laser ridge widths W2, which is generally believed to be 2-3 times the emission wavelength for most semiconductor materials, with the exact value depending on laser type.

An important advantage of the SPP device 10 described herein is the flexibility it provides in implementing plasmonic-based applications and its suitability for integration with electronic and optoelectronic elements. The required processing that combines both the laser 16 and the SPP waveguide 22a is compatible with standard processing by dry or wet etching and optical lithography, although plasmonic optoelectronic circuits with smaller features could also be patterned by e-beam lithography. The architecture disclosed herein provides a flexible platform for plasmonic applications, including the powering of plasmonic circuitry.

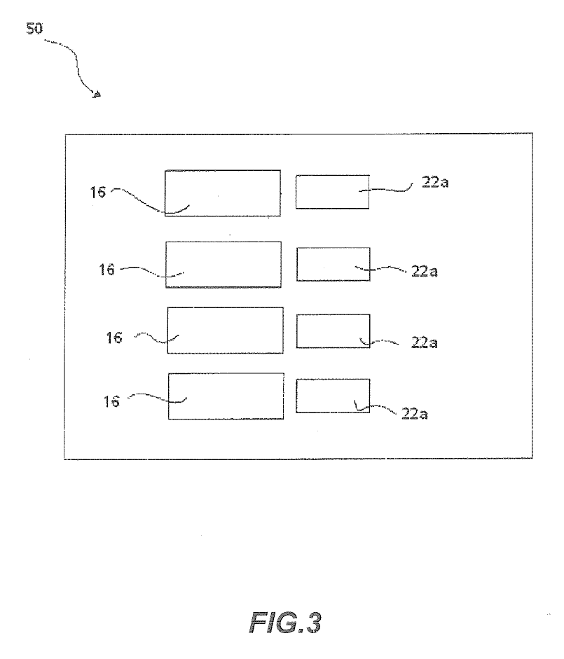

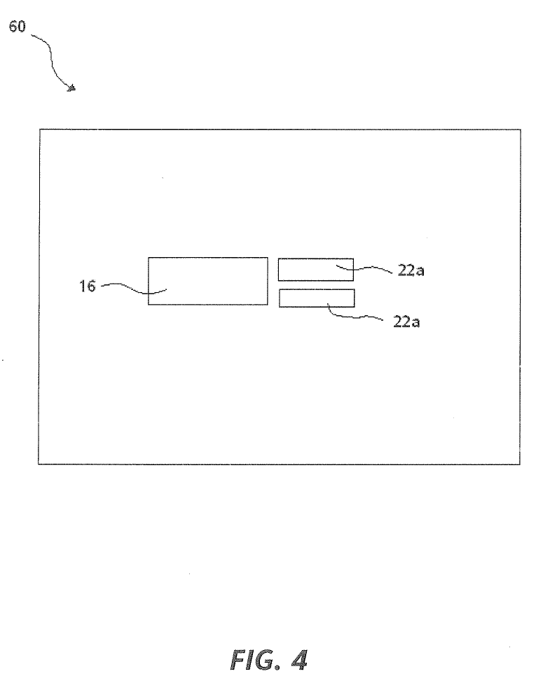

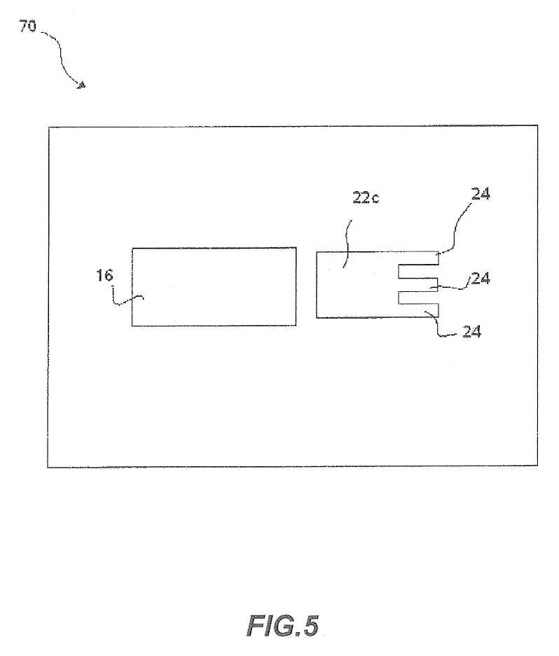

The SPP device 10 is also scalable so as to be able to provide multiple SPP sources integrated on a single micro-chip. FIG. 3 shows a schematic diagram of an SPP device 50 that utilizes multiple lasers 16 and multiple waveguides 22a. As shown in FIG. 4, SPPs may also be achieved by coupling a single laser 16 to multiple waveguides 22a in order to form SPP device 60. As shown in FIG. 5, a single laser 16 may also be coupled to a single waveguide 22c that then branches into subwaveguides 24 in order to form multiple waveguide SPP devices 70.

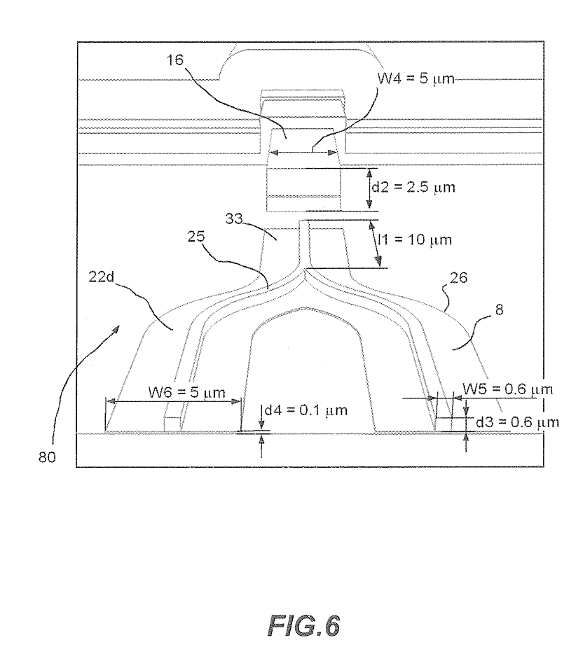

Other plasmonic waveguide designs may also be used. Depending on the polarization of the plasmonic mode supported by the chosen waveguide, diode laser technology can be selected to supply either TM or transverse electric (TE) radiation to best match the plasmonic mode. Variants on the demonstrated planar-stripe waveguide 22a may be seen in FIGS. 6-8, which are discussed below.

FIG. 6 shows a SPP device 80 which includes use of a dielectric ridge 25 deposited on the top surface 8 of the metal film 26 to form waveguide 22d which further confines fields and permits tighter turning radii. In this particular case designed for operation at a wavelength around 1.5 μm, the laser 16 has a width W4 of 5 μm and an etch depth d2 of 2.5 μm. The metal film 26 is comprised of Au with a width W6 of 5.0 μm and a depth d4 of 0.1 μm. The dielectric ridge 25 has a 0.6 μm width W5 and a depth d3 of 0.6 μm. The dielectric ridge 25 also has an end portion 33 with a length 11 of 10 μm. The dielectric material may be any readily fabricated insulating material with low-loss at the operating frequency. Polymers such as polymethyl methacrylate (PMMA) or polystyrene could be used with radiation in the visible or near infrared. Silicon oxide or flowable glass may also be conveniently fabricated into this device. At longer wavelengths, disordered silicon or inorganic II-VI or III-V semiconductors may be used.

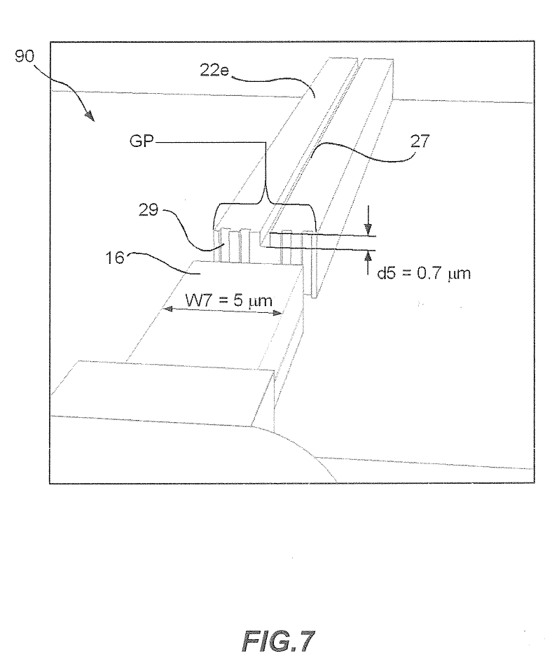

Waveguides with nanoscale transverse dimensions are desirable for increasing the density of optical circuitry. In addition, nanoscale guides may improve sensitivity in sensing applications and may also be employed as light sources for nanoscale optical lithography. FIG. 7 shows a perspective view of a SPP device 90 which includes a nanoscale U-shaped channel 27 in the waveguide 22e. The U-shaped channel has a depth d5 of 0.7 μm. The waveguide 22e has grating 29 for enhanced coupling to the U-channel SPPs. The grating pitch (GP) is close to and somewhat smaller than the wavelength of the emitting laser (by analogy with a second-order grating) and a duty cycle that approaches 50%. The dimensions are selected for optimum coupling of laser-excited SPP modes on the end of the waveguide into in the U-channel SPP modes.

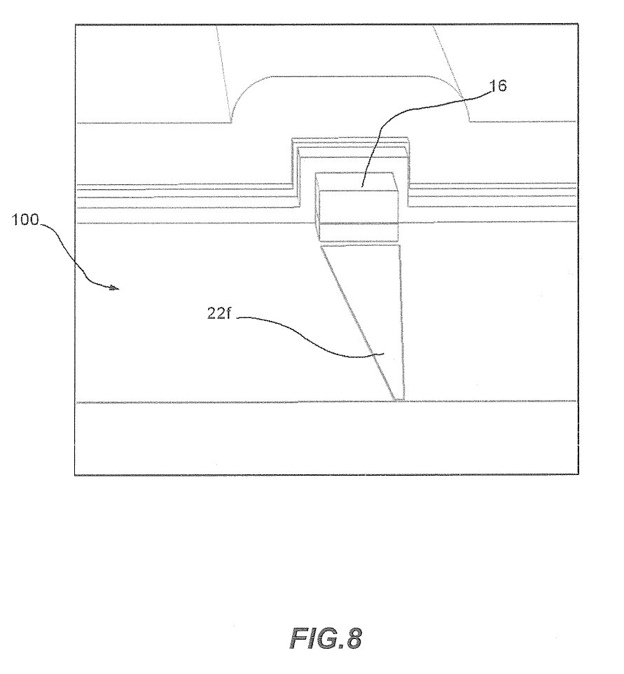

In order to reduce the transverse mode size further, concentrators may be added to most designs. FIG. 8 illustrates the concept of using a taper concentrator with the planar-film waveguide 22f to form SPP device 100. Designs having a tapered waveguide 22f could also be employed with dielectrically loaded guides and channels. If losses do not increase more rapidly than the taper cross-section, larger plasmonic intensities may be realized at the taper tip, which may be of use in nonlinear applications and surface-enhanced Raman sensing. Furthermore, other concentrator designs, such as dielectric lenses added on top of the waveguide may be used. Additional waveguide designs may include planar metal-insulator-metal (MIM) guides, insulator-metal-insulator guides for longer propagation lengths, and designs incorporating hybrid dielectric-metal modes for extreme nanoconfinement.

The coupling scheme shown in FIG. 1 employs a gap 11 between the laser 16 and waveguide 22a. The coupling efficiency increases as the gap 11 distance d1 decreases. Optical lithography limits the gap 11 to sizes larger than about 3 microns. Smaller gaps 11, which are desirable for increased coupling efficiency, may be achieved with electron-beam lithography down to about 100 nm. However, reducing the gap 11 to sizes smaller that ˜λ/10, where λ is the operating laser wavelength, is not necessary as the improvement in coupling efficiency saturates near 60% at this length scale. For coupling to nanochannel plasmonic guides, such as shown in FIG. 7, a simple gap 11 will lead to small coupling efficiencies, but the coupling efficiency can be improved by fabricating a grating 29 on the input end of the metal waveguide 22f facing the laser 16 similar to FIG. 7.

In alternative embodiments, dielectric SPP waveguides may be patterned on the Au film in order to distribute SPP power around the chip as needed. The SPP waveguide is not restricted to using metal stripes: other configurations such as low-loss dielectric-thin metal-dielectric, slot. V-groove etc. are possible. Furthermore, the lasers 16 need not be fabricated as ridge waveguides: buried-heterostructure and gain-guided geometries may also be utilized. The high intensity of the generated SPPs in the present invention is a distinct advantage in such circuits, since inevitable coupling and propagation losses can be tolerated while maintaining a high signal-to-noise ratio.

The ridge laser 16 may also be narrowed to produce better heat sinking and increased output as described above, with the simultaneous advantage of supporting fewer lateral optical modes. Narrower spectral emission may be obtained with only a single lateral mode, and then a distributed-feedback grating within the laser or an external-cavity grating outside the laser would restrict the lasing to a single longitudinal mode. This would improve utility in potential telecommunications or SERS sensing applications. As long as the plasmon waveguide is also narrow enough that only a single lateral mode is supported, the single-mode light from the laser 16 would produce single-mode SPPs in the waveguide. Furthermore, even if the plasmon waveguide is multi-mode, the generated plasmons would still retain the original very narrow spectral width.

An additional feature is that the semiconductor diode structure, besides functioning as a laser gain medium, may also function as a plasmon detector when a metal plasmon waveguide is end-coupled, as described above, to a region where the semiconductor diode is not etched away and the diode is unbiased or reverse-biased rather than forward-biased. The presence of SPPs may then be detected as the extra current in the detector. In this manner, plasmon sources and detectors may be straightforwardly integrated on the same chip, along with other electronic or optoelectronic circuit elements.

In other embodiments, plasmonic concentrators comprising holes, slots, tapers, or raised features may be fabricated directly into the waveguides for nonlinear and nanophotonic applications. The resulting very high plasmon intensities may be useful for nonlinear optical processes. e.g., for nanoscale nonlinear optical frequency converters in a suitable nonlinear medium.

Additionally different types of grating may be used with the SPP device 100. Such possible gratings may be a distributed feedback grating, a distributed Bragg reflector patterned within laser cavity or a grating external to an output facet.

A potential configuration may be an integrated self-contained SERS micro-chip sensor with tiny net volume per device compared to macroscopic spectrometers at the current state of the art. Such micro-sensors would be suitable for implementation on very small platforms; or for distribution in large numbers for a high-resolution distributed sensor network.

An alternative integrated source of SPPs is possible by placing a plasmonic guide on the output facet of the laser 16 or above a vertical-cavity surface emitting laser (VCSEL). Conversion of laser radiation to SPPs running perpendicular to laser propagation would be accomplished with a grating impressed in or on the metal film. As noted above, plasmonic features have been placed on diode-laser output facets, but not to provide a source of SPPs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A surface plasmon polariton device comprising:
a substrate;
a laser for emitting electromagnetic radiation located on the substrate;
a plasmonic waveguide adapted for receiving the electromagnetic radiation, wherein the plasmonic waveguide is located on the substrate:
a gap across which the electromagnetic radiation traverses from the laser to the plasmonic waveguide; and
wherein the plasmonic waveguide converts the electromagnetic radiation into surface plasmon polaritons.

2. The surface plasmon polariton device of claim 1, wherein the electromagnetic radiation emitted by the laser is transverse magnetic polarized.

3. The surface plasmon polariton device of claim 1, wherein the electromagnetic radiation emitted from the laser may be within the range of 0.38-2.0 μm.

4. The surface plasmon polariton device of claim 1, wherein a size of the gap is less than 6.6 μm.

5. The surface plasmon polariton device of claim 1, wherein the waveguide further branches into subwaveguides.

6. The surface plasmon polariton device of claim 1, wherein the waveguide further comprises a surface, wherein a dielectric ridge is located on the surface.

7. The surface plasmon polariton device of claim 1, wherein the laser has an output facet, wherein the output facet has a width no more than 3 times the wavelength of the emitted electromagnetic radiation.

8. The surface plasmon polariton device of claim 1, further comprising a grating selected from the group consisting of a distributed feedback grating, a distributed Bragg reflector patterned within the laser cavity and a grating external to an output facet.

9. The surface plasmon polariton device of claim 1, wherein the plasmonic waveguide has a grating to increase coupling to a subwavelength plasmonic mode.

10. A microchip having a surface plasmon polariton device comprising:
a surface plasmon polariton device integrated on a chip; wherein the surface plasmon polariton device comprises:
a laser for emitting electromagnetic radiation located on a substrate;
a waveguide adapted for receiving the electromagnetic radiation located on the substrate;
a gap across which the electromagnetic radiation traverses; and wherein the waveguide converts the electromagnetic radiation into surface plasmon polaritons.

11. The microchip of claim 10, wherein the electromagnetic radiation emitted by the laser is transverse magnetic polarized.

12. The microchip of claim 10, wherein the electromagnetic radiation emitted from the laser may be within the range of 0.38-2.0 μm.

13. The microchip of claim 10, wherein a size of the gap is less than 6.6 μm.

14. The microchip of claim 10, wherein the waveguide further branches into subwaveguides.

15. The microchip of claim 10, wherein the waveguide has a grating to increase the coupling to the subwavelength plasmonic mode.

16. The microchip of claim 10, further comprising one or more SERS sensing elements to provide an integrated sensing system.

17. The microchip of claim 10, wherein the plasmonic circuit incorporates one or more plasmon detectors formed by zero or reverse biasing the semiconductor diode and detecting the presence of SPPs via changes in the current through the device.

18. The microchip of claim 10, wherein the plasmonic circuit includes concentrators that enhance the intensity of the plasmon field

19. A method of producing surface plasmon polaritons comprising:
producing electromagnetic radiation at a laser located on a substrate:
transmitting the electromagnetic radiation across a gap;
striking a waveguide with the electromagnetic radiation, wherein the waveguide is located on the substrate; and
converting the electromagnetic radiation into surface plasmon polaritons.

20. The method of claim 19, further comprising propagating the surface plasmon polaritons to form a plasmonic circuit including additional optoelectronic device elements on the substrate.
